(19) United States
(12) Patent Application Publication
(10) Pub. No.: US 2021/0049603 A1
(43) Pub. Date: Feb. 18, 2021

(54) SETTLEMENT CHANNEL RECOMMENDATION METHOD, APPARATUS, AND ELECTRONIC DEVICE

(71) Applicant: Advanced New Technologies Co., Ltd., George Town (KY)

(72) Inventors: Hong Jin, Hangzhou (CN); Weiqiang WANG, Hangzhou (CN); Fenghua Yan, Hangzhou (CN)

(73) Assignee: Advanced New Technologies Co., Ltd., George Town (KY)

(21) Appl. No.: 17/086,002

(22) Filed: Oct. 30, 2020

Related U.S. Application Data
(63) Continuation of application No. PCT/CN2019/092765, filed on Jun. 25, 2019.

(30) Foreign Application Priority Data
Aug. 23, 2018 (CN) 201810965369.4

(51) Int. Cl. G06Q 20/40; G06Q 40/04; G06Q 30/02; G06Q 20/08

(52) U.S. Cl. CPC G06Q 20/405; G06Q 20/0855; G06Q 30/0201; G06Q 40/04

(57) ABSTRACT

A settlement channel recommendation computer-implemented method, medium, and system are disclosed. In one computer-implemented method, to-be-selected settlement channels and historical capital transaction information of a target user group is obtained. Respective historical indicator data of each settlement channel of the to-be-selected settlement channels is calculated based on the historical capital transaction information. A respective percentage of each settlement channel of the to-be-selected settlement channels is calculated based on the respective historical indicator data of each settlement channel of the to-be-selected settlement channels and target indicator data. An optimal settlement channel to the target user group is recommended based on the respective percentage of each settlement channel of the to-be-selected settlement channels.

### CROSS-REFERENCE TO RELATED APPLICATIONS

This application is a continuation of PCT Application No. PCT/CN2019/092765, filed on Jun. 25, 2019, which claims priority to Chinese Patent Application No. 201810965369.4, filed on Aug. 23, 2018, and each application is hereby incorporated by reference in its entirety.

### TECHNICAL FIELD

Embodiments of the present application relate to the field of Internet technologies, and in particular, to settlement channel recommendation methods, apparatuses, and electronic devices.

### BACKGROUND

In the financial field, settlement refers to the calculation of the capital flow. As the services continue to grow, the computing resources and time needed for settlement are increasing. In the existing technology, the settlement pressure can be relieved by providing a plurality of settlement centers to distribute the capital flow. Because there are a plurality of settlement institutions, a plurality of settlement channels can be selected, and each settlement channel corresponds to one settlement institution.

With the modification of the settlement rules, the existing settlement channel recommendation methods need to be modified in time, so that the optimal settlement channel can be selected.

### SUMMARY

The present application provides settlement channels recommendation methods and apparatuses, and electronic devices.

According to a first aspect, some embodiments of the present application provide a settlement channel recommendation method, including: obtaining to-be-selected settlement channels and historical capital transaction information of a target user group; calculating historical indicator data of each settlement channel based on the historical capital transaction information; calculating a percentage of each settlement channel based on the historical indicator data and target indicator data; and recommending an optimal settlement channel to the target user group based on the percentage of the settlement channel.

According to a second aspect, some embodiments of the present application provide a settlement channel recommendation method, including: calculating local indicator data corresponding to each type of user group by using the method described in the first aspect; counting the sum of the local indicator data of all user groups; and recommending a corresponding optimal settlement channel to each type of user group when the sum of the local indicator data satisfies the global indicator data.

According to a third aspect, some embodiments of the present application provide a settlement channel recommendation apparatus, including: an acquisition unit, configured to obtaining to-be-selected settlement channels and historical capital transaction information of a target user group; a first calculation unit, configured to calculate historical indicator data of each settlement channel based on the historical capital transaction information; a second calculation unit, configured to calculate a percentage of each settlement channel based on the historical indicator data and target indicator data; and a recommendation unit, configured to recommend an optimal settlement channel to the target user group based on the percentage of the settlement channel.

According to a fourth aspect, some embodiments of the present application provide a settlement channel recommendation apparatus, including: a calculation unit, configured to calculate local indicator data corresponding to each type of user group by using the described in the first aspect; a counting unit, configured to count the sum of the local indicator data of all user groups; and a recommendation unit, configured to recommend a corresponding optimal settlement channel to each type of user group when the sum of the local indicator data satisfies the global indicator data.

According to a fifth aspect, some embodiments of the present application provide an electronic device, including: a processor; and a memory, configured to store a processor executable instruction; where the processor is configured to implement any one of the previous settlement channel recommendation methods.

The embodiments of the present application provide a settlement channel recommendation solution. in the solution, indicator data can reflect the advantages and disadvantages of the settlement channel; after the target indicator data and the historical indicator data are determined, the percentage of each optimal settlement channel is calculated through non-linear programming; and finally, the optimal settlement channel can be recommended to the target user group based on the percentage of the settlement channel. When the indicator data includes a success rate and a rate, in the settlement channel recommendation solution, the recommended settlement channel ensures that the rate is as low as possible while ensuring that the service success rate is satisfied.

### BRIEF DESCRIPTION OF DRAWINGS

FIG. 1 is a schematic diagram illustrating an architecture of a settlement channel recommendation system, according to some embodiments of the present application;

FIG. 2 is a flowchart illustrating a settlement channel recommendation method, according to some embodiments of the present application;

FIG. 3 is a schematic diagram illustrating a hardware structure of a settlement channel recommendation apparatus, according to some embodiments of the present application; and

FIG. 4 is a schematic diagram illustrating modules of a settlement channel recommendation apparatus, according to sonic embodiments of the present application.

### DESCRIPTION OF EMBODIMENTS

Example implementations are described in detail here, and examples of the example implementations are presented in the accompanying drawings. When the following description relates to the accompanying drawings, unless specified otherwise, same numbers in different accompanying drawings represent a same or similar elements. Example embodiments described below do not represent all the embodiments that are consistent with the present application. On the contrary, they are only examples of apparatuses and methods that are described in the appended claims in detail and that are consistent with some aspects of the present application.

The terms used in the present application are merely used for illustrating particular embodiments, and are not intended to limit the present application. The terms “a”, “said”, and “the” of singular forms used in the present application and the appended claims are also intended to include plural forms, unless otherwise specified in the context clearly. It should also be understood that the term “and/or” used here indicates and includes any or all possible combinations of one or more associated listed items.

It should be understood that although terms “first”, “second”, “third”, etc. may be used in the present application to describe various types of information, the information should not be limited by these terms. These terms are only used to differentiate information of a same type. For example, without departing from the scope of the present application, first information can also be referred to as second information, and similarly, the second information can also be referred to as the first information. Depending on the context, for example, the word “if” used here can be explained as “while”, “when”, or “in response to determining”.

As described above, with the modification of the settlement rules, the existing settlement channel recommendation methods need to be corrected in time. Specifically, the Payment and Settlement Department of the People's Bank of China issued a Notice on the Transfer of Network Payment Services of Non-bank Payment Institutions from a Direct Connection Mode to a Networking Platform on Aug. 4, 2017 (hereafter referred to as a notice), which stipulates that from Jun. 30, 2018, all the network payment services involving bank accounts accepted by all the payment institutions shall be processed by the Networking Platform. The third-party payment platform will no longer serve as a settlement institution, and for the third-party payment platform, it is necessary to settle the capital flow through channels such as MYbank, UnionPay, and online bank.

In this case, how to recommend an optimal settlement channel from a variety of settlement channels such as MYbank, UnionPay, and online bank becomes a problem that needs to be urgently alleviated.

To this end, the present application provides a settlement channel recommendation solution, in which the notification content is analyzed with reference to the actual settlement service to obtain the indicator dimensions that can be used for selecting a settlement channel. The indicator dimensions can include at least a success rate and a rate. The success rate can refer to the success rate of settling any capital transaction by the settlement channel. The rate can be a rate used by a settlement channel to settle any capital transaction. The capital transaction can be any type of capital settlement, for example, payment, collection, or transfer.

Generally, a settlement channel recommended to a user needs to satisfy a certain success rate and/or a certain rate. Preferably, the success rate of a target settlement channel needs to be greater than or equal to a target success rate, and less than or equal to a target rate. Such a settlement channel is worth to be recommended.

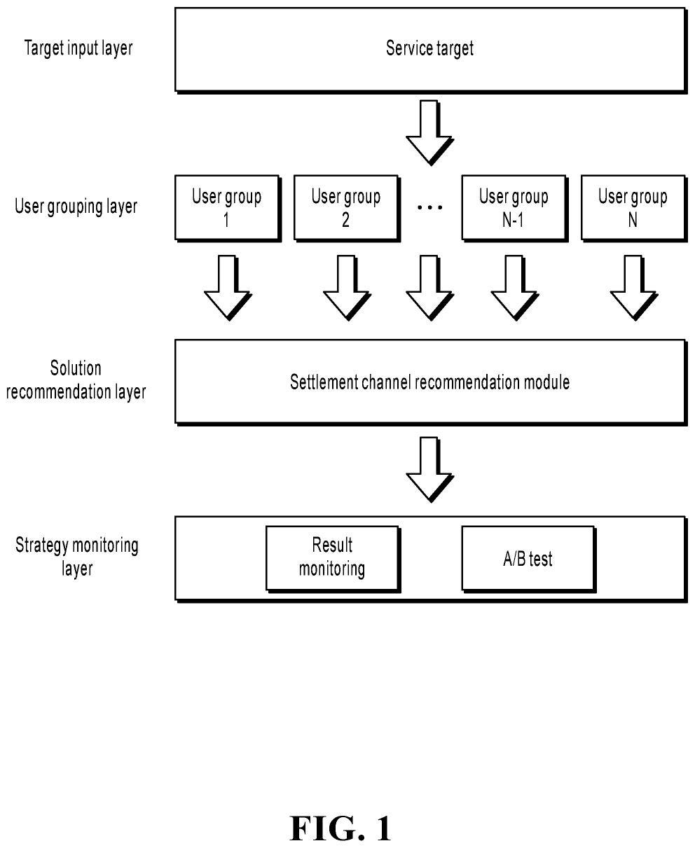

FIG. 1 is a schematic diagram illustrating an architecture of a settlement channel recommendation system provided in the present application. The system architecture can be divided into four layers based on function modules: a target input layer, a user grouping layer, a solution recommendation layer, and a strategy monitoring layer.

The target input layer can be used to obtain a service target. The service target can include target indicator data. The target indicator data. can include a. target rate and/or a target success rate.

Generally, the target indicator data can be an empirical value that is predetermined according to a service need. As service needs change, expectations on recommended settlement channels also change. Then, the target indicator data can be adjusted by re-entering the service target at a server system (for example, the third party payment server system), and then the recommended optimal settlement channel can be flexibly adjusted by re-executing the settlement channel recommendation solution.

The user grouping layer is used to group all users, so that recommendation solutions can be customized for different user groups, and personalized settlement channels can be recommended to the users based on the customized recommendation solutions. In an example, different settlement amount intervals can correspond to different rates and therefore, the settlement amount range in which the user is located can be determined according to the settlement amount of the historical capitals of the user, and the user in the settlement amount range forms a user group. Because the actual rate for each settlement amount area varies from one settlement channel to another, the settlement channel with the lowest actual rate can be recommended to the user. Of course, optimization can be further performed based on the success rate.

The solution recommendation layer is used for recommending, based on an algorithm, different settlement channels for different user groups from a plurality of settlement channels (such as MYbank, UnionPay, and online bank).

The strategy monitoring layer is used to implement A/B test and result monitoring to provide guidance for dynamic adjustment of targets of user groups, etc. In the present solution, through result monitoring, the target is adjusted by the A/B test when the result is abnormal, and the optimal recommended solution can be obtained after the iteration.

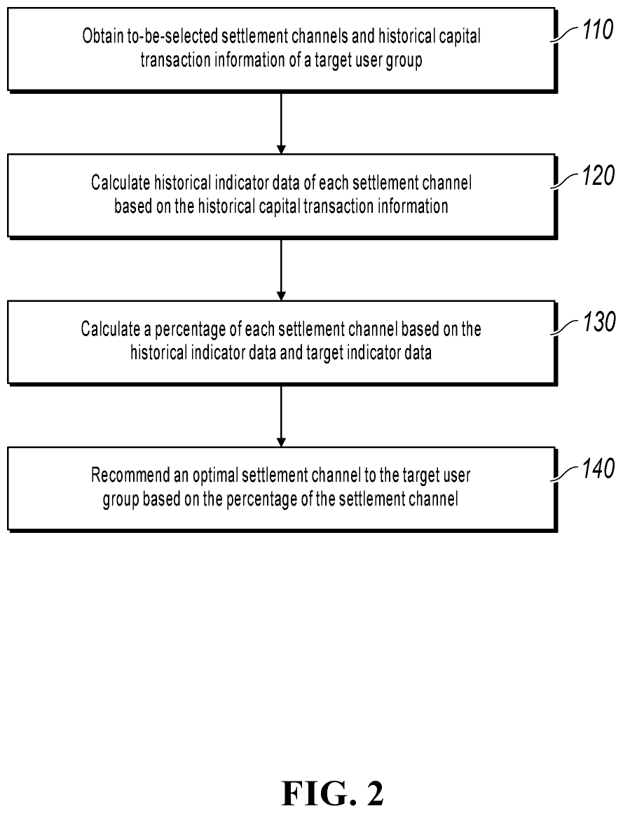

FIG. 2 illustrates another settlement channel recommendation method provided in the present application. The method can include the following steps:

Step 110: Obtain to-be-selected settlement channels and historical capital transaction information of a target user group;

Step 120: Calculate historical indicator data of each settlement channel based on the historical capital transaction information;

Step 130: Calculate a percentage of each settlement channel based on the historical indicator data and target indicator data; and

Step 140: Recommend an optimal settlement channel to the target user group based on the percentage of the settlement channel.

The embodiments provided here can be applied to a server system that is used to recommend a settlement channel. The server system can include a server, a server cluster, or a cloud platform constructed based on a server cluster, such as a third party payment server, a server cluster, or a payment platform constructed based on a server cluster.

In some embodiments, the target indicator data is obtained by inputting the service target at the server system. The target indicator data can include a target rate and/or a target success rate.

Similarly, the historical indicator data can generally include historical rates and/or historical success rates.

As described above, the success rate can refer to the probability of success of the settlement channel in settling any capital transaction; and the rate can be the rate used by the settlement channel to settle any capital transaction. The capital transaction can be any type of capital settlement, for example, payment, collection, or transfer.

In some embodiments, calculating historical indicator data of each settlement channel based on the historical capital transaction information specifically includes: counting the number of attempts of historical capital transactions for each settlement channel; counting the number of successful historical capital transactions for each settlement channel; and calculating a ratio of the number of successes to the number of attempts, and using the ratio as a historical success rate of the settlement channel, where the number of successes is less than or equal to the number of attempts.

The number of historical capital transaction attempts and the number of historical capital transaction successes of each settlement channel are counted by obtaining the historical capital transaction information of all users in the target user group. The number of attempts includes the number of successes and the number of failures. In some embodiments, the number of attempts can also be referred to as the total number. The historical success rate of the settlement channel can be obtained if dividing the number of successes by the number of attempts.

In some embodiments, the rate for each settlement channel can be provided by the service database. Generally, the rate for each settlement channel is determined by the corresponding settlement institution, and the service database can collect and record the historical rate of each settlement channel from public or private channels. When historical rates are needed, the historical rate of each settlement channel can be obtained directly from the corresponding service database. In some cases, the rate of the settlement channel can fluctuate, and the service database needs to periodically update the recorded historical rate so the recorded rate is the latest rate.

In some embodiments, the objective of the present application is to recommend an optimal settlement channel to the target user group. After the target indicator data and the historical indicator data are determined, the objective can be understood as a target to recommend an optimal settlement channel to the target user group when the target (that is, the target indicator data) is given.

Assume that there are n settlement channels and transaction information about m historical capitals; the respective expected target usage percentages for the settlement channels are c1, . . . , cn; the rates corresponding to the settlement channels are f1, . . . , fn; the success rates corresponding to the settlement channel are s1, . . . , sn; and the input target success rate is greater than or equal to S, and the target rate is less than or equal to F;

This problem can be defined as:

$$\{ \begin{matrix}m * c 1 * f 1 + m * c 2 * f 2 + … + m * cn * fn \leq F \\ m * c 1 * s 1 + m * c 2 * s 2 + … + m * cn * sn \geq S\end{matrix} ,$$

the optimal c1, . . . , cn are solved, where the sum of c1, c2, . . . , cn is 100%.

Clearly, this is a typical knapsack problem. Generally, an optimization algorithm can be used to solve such problems.

In some embodiments, calculating a percentage of each settlement channel based on the historical indicator data and target indicator data specifically includes: calculating the percentage of each settlement channel based on the historical indicator data and target indicator data by using an optimization algorithm.

The optimization algorithm can include a genetic algorithm, an ant colony algorithm, a simulated annealing, a gradient descent, etc.

In some embodiments, recommending an optimal settlement channel to the target user group based on the percentage of the settlement channel specifically includes: recommending a settlement channel with the highest percentage to the target user group.

In some embodiments, after the percentage of each settlement channel is calculated, a settlement channel with the highest percentage is recommended to the target user group. A settlement channel recommended in such a method ensures a success rate while ensuring the rate is as low as possible.

Some embodiments of the present application provide a settlement channel recommendation solution. In the solution, by referring to indicator data that can reflect the advantages and disadvantages of the settlement channel; after the target indicator data and the historical indicator data are determined, the percentage of each optimal settlement channel is calculated through non-linear programming; and finally, the optimal settlement channel can be recommended to the target user group based on the percentage of the settlement channel. When the indicator data includes a success rate and a rate, in the settlement channel recommendation solution, the recommended settlement channel ensures that the rate is as low as possible while ensuring that the service success rate is satisfied.

Some embodiments of the present application provide another settlement channel recommendation method. The method can include:

A1: Calculate local indicator data corresponding to each type of user group by using the solution described in FIG. 1;

A2: Calculate the sum of local indicator data of all user groups;

A3: When the sum of the local indicator data satisfies the global indicator data, recommend a corresponding optimal settlement channel to each type of user group;

A4: When the sum of the local indicator data does not need to satisfy the global indicator data, adjust the local indicator data corresponding to different user groups; and

A5: Recalculate the percentage of each settlement channel of each type of user group based on the adjusted local indicator data, until the sum of the local indicator data satisfies the global indicator data.

As shown in FIG. 1, the user grouping layer divides all users into several user groups. The steps of the embodiment described in FIG. 2 are performed on each type of user group. The target indicator data of each type of user group mentioned above can be referred to as local indicator data in order to distinguish the target indicator data of each type of user group from the previous target indicator data; which is corresponding to the global indicator data in some embodiments. Both the local indicator data and the global indicator data can be empirical values that are predetermined manually according to service needs. The strategy monitoring layer can monitor the result, that is, monitor whether the local indicator data satisfies the global indicator data. When the local indicator data. does not satisfy the global indicator data, iterative processing is performed based on the A/B test.

In one case, the sum of the local indicator data satisfies the global indicator data, indicating that the solution recommended to each type of user group can generally satisfy the global target. Therefore, an optimal settlement channel can be recommended to each type of user group according to the solution recommended to each type of user group.

In another case, the sum of the local indicator data does not need to satisfy the global indicator data, indicating that there're problems with solution recommended to each type of user group. Therefore, the solution can be adjusted as follows: adjusting local indicator data corresponding to different user groups; and recalculating the percentage of each settlement channel of each type of user group based on the adjusted local indicator data, until the sum of the local indicator data satisfies the global indicator data.

In some embodiments, a success rate and/or a rate are/is used as an example for description.

Adjusting local indicator data corresponding to different user groups can specifically include: increasing the local rates corresponding to different user groups, and/or decreasing the local success rates corresponding to different user groups; recalculating the percentages c1, . . . , cn of the settlement channels of the user groups based on the adjusted local success rates and/or the adjusted rates; and repeating the above steps until the sum of the local indicator data satisfies the global indicator data.

The process of increasing the local rates or decreasing the local success rates can be performed on all user groups based on equal percentages.

According to some embodiments, when the solution recommended to the local user group achieves the local objective, the overall solution can be optimized from a global perspective.

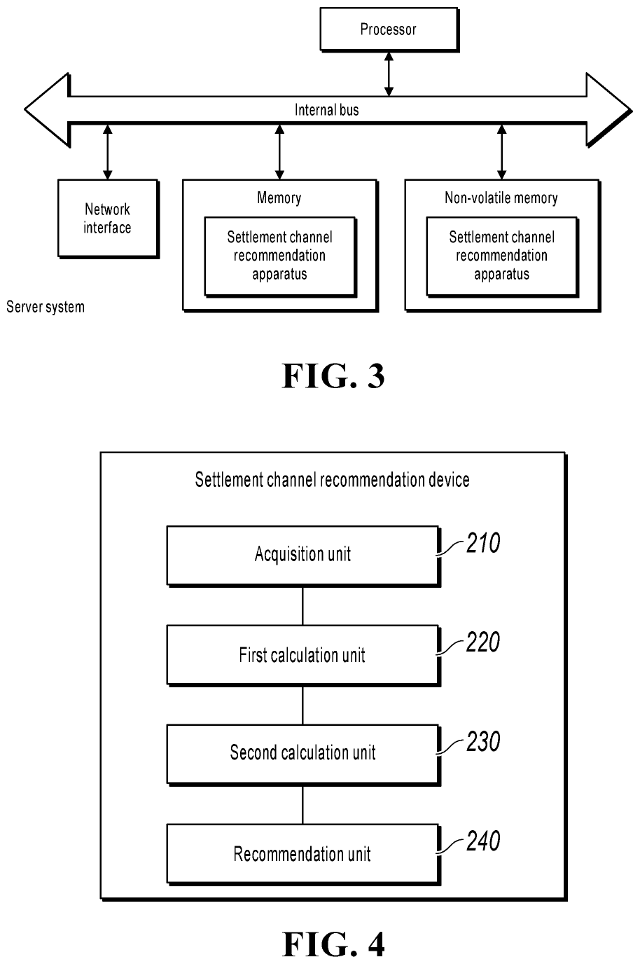

Corresponding to the previous settlement channel recommendation method embodiments, the present application further provides sonic embodiments of a settlement channel recommendation apparatus. The apparatus embodiments can be implemented by using software, hardware, or a combination of software and hardware. The software embodiment is used as an example. As a logical apparatus, the apparatus is formed by reading the corresponding computer program instructions in the non-volatile memory by the processor of the device in which the apparatus is located into the memory for execution. In terms of hardware, FIG. 3 is a diagram illustrating a hardware structure of a device in which a settlement channel recommendation apparatus is located. In addition to a processor, a memory, a network interface, and a non-volatile memory shown in FIG. 3, the device in Which the apparatus is located can generally include other hardware based on other actual functions of the settlement channel recommendation apparatus. Details are omitted here for simplicity.

FIG. 4 is a schematic diagram illustrating modules of a settlement channel recommendation apparatus, according to some embodiments of the present application. The apparatus corresponds to the embodiment shown in FIG. 2. The apparatus includes: an acquisition unit 210, configured to obtaining to-be-selected settlement channels and historical capital transaction information of a target user group; a first calculation unit 220, configured to calculate historical indicator data of each settlement channel based on the historical capital transaction information; a second calculation unit 230, configured to calculate a percentage of each settlement channel based on the historical indicator data and target indicator data; and a recommendation unit 240, configured to recommend an optimal settlement channel to the target user group based on the percentage of the settlement channel.

Optionally, the indicator data includes a success rate and/or a rate.

Optionally, the first calculation unit 220 specifically includes: a first counting subunit, configured to count the number of attempts of historical capital transactions for each settlement channel; a second counting subunit, configured to count the number of successful historical capital transactions for each settlement channel; and a calculation subunit, configured to calculate a ratio of the number of successes to the number of attempts, and use the ratio as a historical success rate of the settlement channel, where the number of successes is less than or equal to the number of attempts.

Optionally, the second calculation unit 230 is specifically configured to: calculate a percentage of each settlement channel based on the historical indicator data and target indicator data.

Optionally, the optimization algorithms include: a genetic algorithm and an ant colony algorithm.

Optionally, the second calculation unit 230 is specifically configured to: calculate a percentage of each settlement channel based on

$$\{ \begin{matrix}m * c 1 * f 1 + m * c 2 * f 2 + … + m * cn * fn \leq F \\ m * c 1 * s 1 + m * c 2 * s 2 + … + m * cn * sn \geq S\end{matrix} ,$$

where m indicates the number of pieces of information about historical transactions, and f1, f2, . . . , fn indicates the rates of n settlement channels; s1, s2, . . . , sn indicate the success rates of n settlement channels; F indicates the target rate; and S indicates the target success rate; c1, c2, . . . , cn indicate the percentages of the n settlement channels, and the sum of c1, c2, . . . , cn is 100%.

Optionally, the recommendation unit 240 is specifically configured to: recommend a settlement channel with the highest percentage to the target user group.

The following describes a schematic diagram illustrating modules of a. settlement channel recommendation apparatus that corresponds to another recommendation method and that is provided in the present application. The apparatus includes: a calculation unit, configured to calculate local indicator data corresponding to each type of user group by using the solution described in FIG. 1; a counting unit, configured to count the sum of the local indicator data of all user groups; and a recommendation unit, configured to recommend a corresponding optimal settlement channel to each type of user group when the sum of the local indicator data satisfies the global indicator data.

Optionally, the apparatus further includes: an adjustment unit, configured to adjust the local indicator data corresponding to different user groups when the sum of the local indicator data does not satisfy the global indicator data; and a control unit, configured to recalculate the percentage of each settlement channel of each type of user group based on the adjusted local indicator data, until the sum of the local indicator data satisfies the global indicator data.

Optionally, the indicator data includes a success rate and/or a rate; and adjusting local indicator data corresponding to different user groups specifically includes: increasing the local rates corresponding to different user groups; and/or, decreasing the local success rates corresponding to different user groups.

The system, apparatus, module, or unit illustrated in the previous embodiments can be implemented by using a computer chip or an entity, or can be implemented by using a product having a certain function. A typical implementation device is a computer in the form of a personal computer, a laptop computer, a cellular phone, a camera phone, a smart phone, a personal digital assistant, a media player, a navigation device, an e-mail transceiver, a game console, a tablet computer, a wearable device, or any combination of at least two of these devices.

For the detailed implementation process of the functions and purposes of the units in the apparatus, references can be made to the implementation process of the corresponding steps in the method, and details are omitted here for simplicity.

Because the apparatus embodiment basically corresponds to the method embodiment, for the related parts, references can be made to the description of the method embodiment. The described apparatus embodiments are merely examples, where the units described as separate parts may or may not be physically separate, and parts displayed as units can be or does not have to be physical units, can be located in one place, or can be distributed on a plurality of network units. Based on the practical needs, some or all of these modules can be selected to implement the purpose of the present application. A person of ordinary skill in the art can understand and implement the technical solutions in some embodiments without creative efforts.

FIG. 4 above describes function modules and the structure of a settlement channel recommendation apparatus. The executing body can be an electronic device, including: a processor; and a memory, configured to store a processor executable instruction; where the processor is configured to: obtain to-be-selected settlement channels and historical capital transaction information of a target user group; calculate historical indicator data of each settlement channel based on the historical capital transaction information; calculate a percentage of each settlement channel based on the historical indicator data and target indicator data; and recommend an optimal settlement channel to the target user group based on the percentage of the settlement channel.

Optionally, the indicator data includes a success rate and/or a rate.

Optionally, calculating historical indicator data of each settlement channel based on the historical capital transaction information specifically includes: counting the number of attempts of historical capital transactions for each settlement channel; counting the number of successful historical capital transactions for each settlement channel; and calculating a ratio of the number of successes to the number of attempts, and using the ratio as a historical success rate of the settlement channel, where the number of successes is less than or equal to the number of attempts.

Optionally, calculating a percentage of each settlement channel based on the historical indicator data and target indicator data specifically includes: calculating the percentage of each settlement channel based on the historical indicator data and target indicator data by using an optimization algorithm.

Optionally, the optimization algorithms include: a genetic algorithm and an ant colony algorithm.

Optionally, calculating a percentage of each settlement channel based on the historical indicator data and target indicator data specifically includes: calculating a percentage of each settlement channel based on

$$\{ \begin{matrix}m * c 1 * f 1 + m * c 2 * f 2 + … + m * cn * fn \leq F \\ m * c 1 * s 1 + m * c 2 * s 2 + … + m * cn * sn \geq S\end{matrix} ,$$

where m indicates the number of pieces of information about historical transactions, and f1, f2, . . . , fn indicates the rates of n settlement channels; s1, s2, . . . , sn indicate the success rates of n settlement channels; F indicates the target rate; and S indicates the target success rate; c1, c2, . . . , cn indicate the percentages of then settlement channels, and the sum of c1, c2, . . . , cn is 100%.

Optionally, recommending an optimal settlement channel to the target user group based on the percentage of the settlement channel specifically includes: recommending a settlement channel with the highest percentage to the target user group.

The function modules and the structure of another settlement channel recommendation apparatus are described above. The executing body can be an electronic device, including: a processor; and a memory, configured to store a processor executable instruction; where the processor is configured to: calculate local indicator data corresponding to each type of user group by using the method described in FIG. 1; count the sum of the local indicator data of all user groups; and recommend a corresponding optimal settlement channel to each type of user group when the sum of the local indicator data satisfies the global indicator data.

Optionally, the processor is further configured to: adjust the local indicator data corresponding to different user groups when the sum of the local indicator data does not satisfy the global indicator data; and recalculate the percentage of each settlement channel of each type of user group based on the adjusted local indicator data, until the sum of the local indicator data satisfies the global indicator data.

Optionally, the indicator data includes a success rate and/or a rate; and adjusting local indicator data corresponding to different user groups specifically includes: increasing the local rates corresponding to different user groups; and/or, decreasing the local success rates corresponding to different user groups.

In the previous embodiment of the electronic device, it should be understood that the processor can be a central processing unit (CPU), or can be another general purpose processor, a digital signal processor (DSP), an application-specific integrated circuit (ASIC), etc. The general-purpose processor can be a microprocessor or the processor can be any conventional processor etc., and the memory can be a read-only memory (ROM), a random access memory (RAM), a flash memory, a hard disk, or a solid state disk. The steps of the method disclosed in connection with the embodiments of the present application can be directly performed by a hardware processor, or can be performed by a combination of hardware and software modules in a processor.

The embodiments of the present application are described in a progressive method. For same or similar parts of the embodiments, mutual references can be made to the embodiments. Each embodiment focuses on a difference from the other embodiments. Particularly, an electronic device embodiment is basically similar to a method embodiment, and therefore is described briefly. For related parts, references can he made to related descriptions in the method embodiment.

A person skilled in the art can easily figure out other embodiments of the present application after considering and practicing the present application disclosed here. The present application is intended to cover any variations, usage, or adaptations of the present application that follow the general principles of the present application and include common general knowledge or commonly used technical means in the art that are not disclosed in the present application. The present application and embodiments are merely examples. The protection scope and spirit of the present application are indicated by the following claims.

It should be understood that the present application is not limited to the precise structures already described above and illustrated in the accompanying drawings, and various modifications and changes can be made without departing from the scope thereof. The protection scope of the present application should be defined by the appended claims.

What is claimed is:

1. A computer-implemented method for settlement channel recommendation, comprising:
obtaining to-be-selected settlement channels and historical capital transaction information of a target user group;
calculating respective historical indicator data of each settlement channel of the to-be-selected settlement channels based on the historical capital transaction information;
calculating a respective percentage of each settlement channel of the to-be-selected settlement channels based on the respective historical indicator data of each settlement channel of the to-be-selected settlement channels and target indicator data; and
recommending an optimal settlement channel to the target user group based on the respective percentage of each settlement channel of the to-be-selected settlement channels.

2. The computer-implemented method of claim 1, wherein the respective historical indicator data of each settlement channel comprises a respective historical success rate or a respective historical rate, and wherein the target indicator data comprises a target success rate or a target rate.

3. The computer-implemented method of claim 2, wherein calculating respective historical indicator data of each settlement channel based on the historical capital transaction information comprises:
determining a respective number of attempts of historical capital transactions for each settlement channel;
determining a respective number of successful historical capital transactions for each settlement channel;
calculating for each settlement channel a respective ratio of the respective number of successful historical capital transactions to the respective number of attempts; and
setting the respective ratio as the respective historical success rate for each settlement channel, wherein the respective number of successful historical capital transactions is less than or equal to the respective number of attempts.

4. The computer-implemented method of claim 1, wherein calculating a respective percentage of each settlement channel of the to-be-selected settlement channels based on the respective historical indicator data of each settlement channel and target indicator data comprises calculating a respective percentage of each settlement channel of the to-be-selected settlement channels based on the respective historical indicator data and target indicator data. using optimization algorithms.

5. The computer-implemented method of claim 4, wherein the optimization algorithms comprise a genetic algorithm and an ant colony algorithm.

6. The computer-implemented method of claim 2, wherein calculating a respective percentage of each settlement channel of the to-be-selected settlement channels based on the respective historical indicator data and target indicator data comprises:
calculating a respective percentage of each settlement channel based on
$$\{ \begin{matrix}m * c 1 * f 1 + m * c 2 * f 2 + … + m * cn * fn \leq F \\ m * c 1 * s 1 + m * c 2 * s 2 + … + m * cn * sn \geq S\end{matrix} ,$$
wherein m represents a number of pieces of information about historical transactions, wherein f1, f2, . . . , fn represent historic rates of n settlement channels, wherein s1, s2, . . . , sn represent historic success rates of n settlement channels, wherein F represents the target rate, wherein S represents the target success rate, wherein c1, c2, . . . , cn represent percentages of the n settlement channels, and wherein a sum of c1, c2, . . . , cn equals 100%.

7. The computer-implemented method of claim 1, wherein recommending an optimal settlement channel to the target user group based on the respective percentage of each settlement channel comprises recommending to the target user group a settlement channel with the highest percentage among the to-be-selected settlement channels.

8. A non-transitory, computer-readable medium storing one or more instructions executable by a computer system to perform operations fur settlement channel recommendation, the operations comprising:
obtaining to-be-selected settlement channels and historical capital transaction information of a target user group;
calculating respective historical indicator data of each settlement channel of the to-be-selected settlement channels based on the historical capital transaction information;
calculating a respective percentage of each settlement channel of the to-be-selected settlement channels based on the respective historical indicator data of each settlement channel of the to-be-selected settlement channels and target indicator data; and
recommending an optimal settlement channel to the target user group based on the respective percentage of each settlement channel of the to-be-selected settlement channels.

9. The non-transitory, computer-readable medium of claim 8, wherein the respective historical indicator data of each settlement channel comprises a respective historical success rate or a respective historical rate, and wherein the target indicator data comprises a target success rate or a target rate.

10. The non-transitory, computer-readable medium of claim 9, wherein calculating respective historical indicator data of each settlement channel based on the historical capital transaction information comprises:
determining a respective number of attempts of historical capital transactions for each settlement channel;
determining a respective number of successful historical capital transactions for each settlement channel;
calculating for each settlement channel a respective ratio of the respective number of successful historical capital transactions to the respective number of attempts; and
setting the respective ratio as the respective historical success rate for each settlement channel, wherein the respective number of successful historical capital transactions is less than or equal to the respective number of attempts.

11. The non-transitory, computer-readable medium of claim 8, wherein calculating a respective percentage of each settlement channel of the to-be-selected settlement channels based on the respective historical indicator data of each settlement channel and target indicator data comprises calculating a respective percentage of each settlement channel of the to-be-selected settlement channels based on the respective historical indicator data and target indicator data using optimization algorithms.

12. The non-transitory, computer-readable medium of claim 11, wherein the optimization algorithms comprise a genetic algorithm and an ant colony algorithm.

13. The non-transitory, computer-readable medium of claim 9, wherein calculating a respective percentage of each settlement channel of the to-be-selected settlement channels based on the respective historical indicator data and target indicator data comprises:
calculating a respective percentage of each settlement channel based on
$$\{ \begin{matrix}m * c 1 * f 1 + m * c 2 * f 2 + … + m * cn * fn \leq F \\ m * c 1 * s 1 + m * c 2 * s 2 + … + m * cn * sn \geq S\end{matrix} ,$$
wherein m represents a number of pieces of information about historical transactions, wherein f1, f2, . . . , fn represent historic rates of n settlement channels, wherein s1, s2, . . . , sn represent historic success rates of n settlement channels, wherein F represents the target rate, wherein S represents the target success rate, wherein c1, c2, . . . , cn represent percentages of the n settlement channels, and wherein a sum of c1, c2, . . . , cn equals 100%.

14. The non-transitory, computer-readable medium of claim 8, wherein recommending an optimal settlement channel to the target user group based on the respective percentage of each settlement channel comprises recommending to the target user group a settlement channel with the highest percentage among the to-be-selected settlement channels.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for settlement channel recommendation, the operations comprising:
obtaining to-be-selected settlement channels and historical capital transaction information of a target user group;
calculating respective historical indicator data of each settlement channel of the to-be-selected settlement channels based on the historical capital transaction information;
calculating a respective percentage of each settlement channel of the to-be-selected settlement channels based on the respective historical indicator data of each settlement channel of the to-be-selected settlement channels and target indicator data; and
recommending an optimal settlement channel to the target user group based on the respective percentage of each settlement channel of the to-be-selected settlement channels.

16. The computer-implemented system of claim 15, wherein the respective historical indicator data of each settlement channel comprises a respective historical success rate or a respective historical rate, and wherein the target indicator data comprises a target success rate or a target rate.

17. The computer-implemented system of claim 16, wherein calculating respective historical indicator data of each settlement channel based on the historical capital transaction information comprises:
determining a respective number of attempts of historical capital transactions for each settlement channel;
determining a respective number of successful historical capital transactions for each settlement channel;
calculating for each settlement channel a respective ratio of the respective number of successful historical capital transactions to the respective number of attempts; and
setting the respective ratio as the respective historical success rate for each settlement channel, wherein the respective number of successful historical capital transactions is less than or equal to the respective number of attempts.

18. The computer-implemented system of claim 15, wherein calculating a respective percentage of each settlement channel of the to-be-selected settlement channels based on the respective historical indicator data of each settlement channel and target indicator data comprises calculating a respective percentage of each settlement channel of the to-be-selected settlement channels based on the respective historical indicator data and target indicator data. using optimization algorithms.

19. The computer-implemented system of claim 18, wherein the optimization algorithms comprise a genetic algorithm and an ant colony algorithm.

20. The computer-implemented system of claim 15, wherein recommending an optimal settlement channel to the target user group based on the respective percentage of each settlement channel comprises recommending to the target user group a settlement channel with the highest percentage among the to-be-selected settlement channels.
